(19) United States
(12) Patent Application Publication
(10) Pub. No.: US 2015/0062086 A1
(43) Pub. Date: Mar. 5, 2015

(54) METHOD AND SYSTEM OF A WEARABLE RING DEVICE FOR MANAGEMENT OF ANOTHER COMPUTING DEVICE

(71) Applicant: ROHILDEV NATTUKALLINGAL, Malappuram (IN)

(72) Inventor: ROHILDEV NATTUKALLINGAL, Malappuram (IN)

(21) Appl. No.: 14/468,333

(22) Filed: Aug. 26, 2014

Related U.S. Application Data
(60) Provisional application No. 62/009,161, filed on Jun. 7, 2014.

(30) Foreign Application Priority Data
Aug. 29, 2013 (IN) 3853/CHE/2013

(51) Int. Cl. G06F 3/01; G06F 3/042

(52) U.S. Cl. CPC G06F 3/017; G06F 3/0425
USPC 345/175

(57) ABSTRACT

In one exemplary aspect, a method of a wearable ring device senses a touch event with a touch sensor in a wearable ring device. An optical sensor in the wearable ring device is activated. A digital image of a user hand region is obtained with the optical sensor. A list of end device functions is obtained. Each element of the list of end device functions is associated with a separate user hand region. The digital image of the user hand region obtained with the optical sensor is matched with an end device function. The end device function matched with the digital image of the user hand region obtained with the optical sensor is trigger.

### CROSS-REFERENCE TO RELATED APPLICATIONS

This application is a claims priority from U.S. Provisional Application No. 62/009,161, titled METHOD AND SYSTEM OF A WEARABLE RING DEVICE FOR ACCESS TO ANOTHER COMPUTING DEVICE and filed Jun. 7, 2014. This application is hereby incorporated by reference in its entirety by reference.

This application claims priority under 35 U.S.C. §119 to Indian Patent Application Number 3853/CHE/2013, titled, and filed at the Indian Patent Office on Sep. 29, 2013. This application is hereby incorporated by reference in its entirety by reference.

### FIELD OF THE INVENTION

The invention is in the field of computer interfaces and more specifically to a method, system and apparatus of a wearable ring device for management of another computing device.

### DESCRIPTION OF THE RELATED ART

Mobile devices, such as personal digital assistants (“PDAs”), smart phones wearable computers (e.g. smart watches, optical head-mounted displays, etc.), have increased in popularity. More users use mobile devices as their primary computing systems in many contexts. Current user interfaces mobile devices have various limitations. For example, touch screen require a user to show others that he/she is utilizing a smart phone. The user may want to manage certain smart phone functions surreptitiously. In another example, some mobile devices such as some wearable computing systems may lack a touch screen or other interface and rely on limited touch and/or voice input methods. Input into said may benefit from additional input/interface systems. In view of this, improvements may be made over conventional methods.

### BRIEF SUMMARY OF THE INVENTION

In one aspect, a method of a wearable ring device senses a touch event with a touch sensor in a wearable ring device. An optical sensor in the wearable ring device is activated. A digital image of a user hand region is obtained with the optical sensor. A list of end device functions is obtained. Each element of the list of end device functions is associated with a separate user hand region. The digital image of the user hand region obtained with the optical sensor is matched with an end device function. The end device function matched with the digital image of the user hand region obtained with the optical sensor is trigger.

Optionally, the end device can be a mobile device. The mobile device can be a smart phone, any other Bluetooth or WIFI enable smart device (like Home Automation devices, Automobile, Smart TV, Computers etc.), or an optical head-mounted display device. The function can include turning off a ringtone played by the smart phone or obtaining another digital image with a digital camera associated of the optical head-mounted display.

### BRIEF DESCRIPTION OF THE DRAWINGS

FIG. 1 depicts an example process of user interaction with wearable ring device, according to some embodiments

FIG. 2 depicts a block diagram of an example set of modules of a wearable ring device operating system, according to some embodiments.

FIG. 3 depicts a block diagram of a system that includes a wearable ring device and an end device, according to some embodiments.

FIGS. 4-7 illustrate example schematics of a wearable ring device worn by a user, according to some embodiments.

FIGS. 8A and 8B depicts an example system of implementing multiple functions in multiple end-devices with a single wearable ring computer, according to some embodiments.

FIG. 9 depicts computing system With a number of components that may be used to perform any of the processes described herein.

FIG. 10 illustrates an example of a wearable ring that utilizes an OFN sensor to recognize the gesture that making on any surface, according to some embodiments.

FIG. 11 illustrates an example of gesture controls by moving a thumb to perform gestures over one or more fingers, according to some embodiments.

FIG. 12 illustrates another example of gesture controls by moving a thumb to perform gestures over one or more fingers, according to some embodiments.

The Figures described above are a representative set, and are not an exhaustive with respect to embodying the invention.

### DESCRIPTION

Disclosed are a system, method, and article of manufacture of computer-implemented wearable ring device for user access to another computing device (e.g. an end device). The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Access to another computing device can include, inter alia, providing user input to and/or receiving user output from said computing device via an interface on a wearable ring device.

Digital signal processing can include the mathematical manipulation of an information signal.

Digital signal processor (DSP) can include a microprocessor designed for digital signal processing.

Gesture recognition can include system and algorithms that interpret human gestures (e.g. finger gestures, hand gestures, etc.) via mathematical algorithms. In some examples, gestures can originate from any bodily motion or state.

Haptics can be a tactile feedback technology which recreates the sense of touch by applying forces, vibrations, or motions to a user.

Inertial measurement unit (IMU) can be an electronic device that measures and reports on a digit's (e.g. a finger, a toe, etc.) motion attribute (e.g. velocity, orientation, gravitational forces, etc.). The IMU can use a combination of such devices, as, inter alia: accelerometers and gyroscopes and/or magnetometers. In some examples, any body part capable of motion can have its motion attributes monitored by an IMU.

Optical sensor can be a digital camera that encodes digital images and videos digitally.

### EXAMPLE METHODS

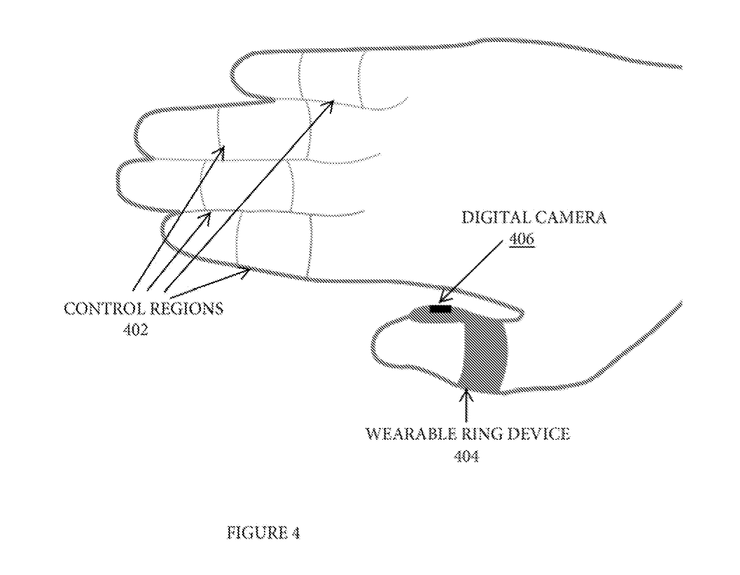

Computerized methods and systems of a wearable ring device can include provided various ways for a user to interact with another computing device (e.g. a mobile device such as a smart phone, tablet computer, other wearable computing system, a smart telephone, augmented-reality head-mounted display, smart television system, wearable-body sensors, home automation systems, smart refrigerator systems, automobile computing systems, computing systems integrated into consumer goods, etc.). In one example, it can be detected that a user is touching on the palm using the wearable ring device worn on user's thumb. The wearable ring device can include a skin detector sensor that can identify a user touch event. The skin detection sensor can communicate signal values indicating the touch event to a processor in the wearable ring device. The processor can then identify the touch event with various signal recognition techniques. The processor can then communicate acknowledgment of the detected touch event to an active optical sensor and/or IMU. The optical sensor can obtain an image of the attributes of a region of the user's hand/fingers (e.g. see control regions 402 infra in FIG. 4) that are in the view of the optical sensor. For example, the optical sensor can obtain an image of the phalanges and/or the lines of a finger near the user's thumb, it is noted that the digital image can be saved to a database in the apparatus itself.

The captured digital images can be processed in the wearable ring device. For example, a DSP can identify the number of lines in the image and calculate the distance between the lines. This can be used as a user authentication technique for access to an end computing device. Additionally, the DSP can identify the length and difference between each line. These values can also be saved in the database of the wearable ring device itself.

In one example, various training and/or initialization processes can be performed so that the wearable ring device can register/save a the attributes of a region of the user's hand/fingers that are in the viewable by the optical sensor (e.g. the user's phalange and line shapes, median ridges distances for a user in a user of skin of a user's finger, etc.). Accordingly, after the configuration/set up is completed, one or more wearable ring devices can be worn by the user. For example, a wearable ring device can be worn on the user's thumb. A detected touch event on the wearable ring device can cause the touch sensor (e.g. a device such as a force-sensitive switch, a capacitance sensor, capacitive proximity sensors, etc. that uses contact to generate feedback in computing system) to communicate the values to processor to active optical sensor and IMU and/or optical finger navigation (OFN). Digital images of the user's phalange and/or line shapes can then be obtained using Optical sensor. These digital images can be sent to the DSP. DSP can process the image and identify the unique properties of the skin of the user's phalanges and/or figure lines (or other user hand/finger skin attributes in other examples). These properties can be compared with the database data in the apparatus. If a match is determined, then the values and/or other command can then be sent end device via a wireless communication protocol (e.g. Bluetooth® and/or other communication medium). For example, when detecting a gesture, an IMU sensor can obtain and communicate the x,y,z coordinate values and an OFN sensor can measure and communicate x,y coordinate values and/or other command can be process to a microcontroller for this information can be sent to an end device via a wireless communication protocol (e.g. Bluetooth® and/or other communication medium)).

Digital images of various user finger/hand regions can be associated with various command inputs. Specified tolerance thresholds can be assigned. For example, when digital image include at least eighty percent of a skin portion of a phalange region of the user's right index finger then communicate a command to take a picture with the user's Google Glass® device to said device. Additionally, in some examples, the wearable ring device can include various system for detecting user gesture patterns. User gesture patterns, digital images of various user finger/hand regions and/or a combination thereof can be used as input for an end device.

In the event that a user is wearing multiple ring devices, each ring device can be associated with a separate end device. For example, a ring device on the thumb of the right hand can be associated with the user's smart phone. A ring device on the thumb of the left hand can be associated with the user's head-mounted augmented display (e.g. a pair of Google Glass®). A ring device on a user's right index finger can be associated with a television's remote controller. The ring device can be used to control end devices from a hand within an enclosed space (e.g. a pants pocket, a coat pockets, underneath a surface, etc.). These examples are provided by way of example and not of limitation.

### EXAMPLES METHODS AND SYSTEMS

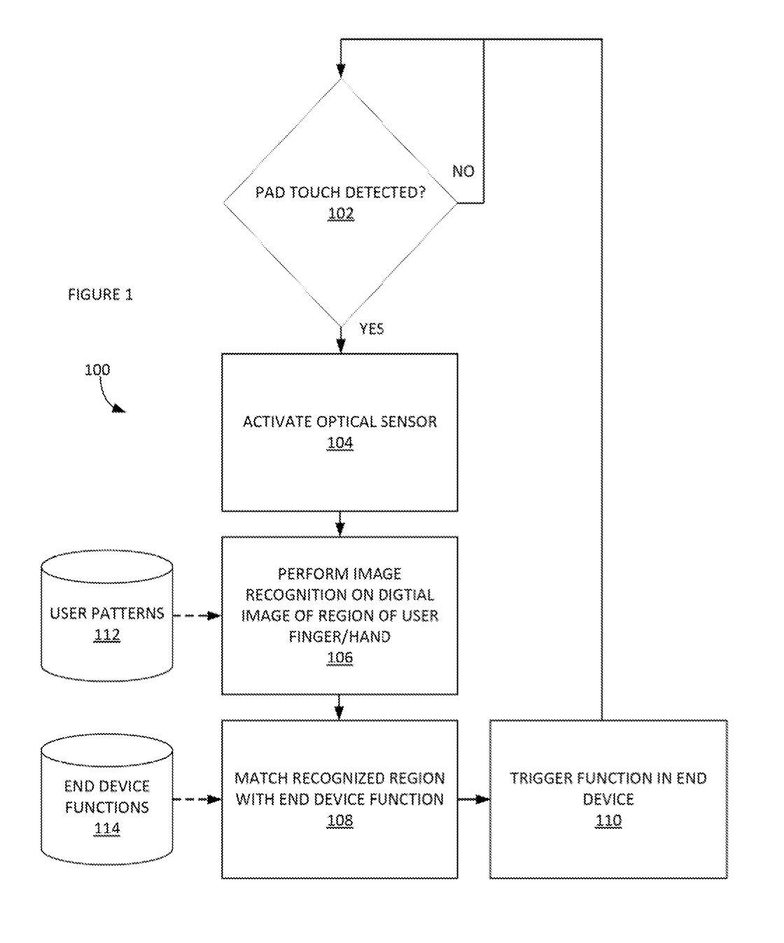

FIG. 1 depicts an example process 100 of user interaction with wearable ring device, according to some embodiments. In step 102 of process 100, it is determined if a touch event has been detected. If no, then process continues to wait for a touch event to be detected. If yes, process 100 can process to step 104. In step 104, an optical sensor can be activated. The optical sensor can obtain digital image(s) of a region of skirt of a user's finger/hand. In step 106, image/pattern recognition can be performed on the digital image(s) of the region of skin of a user's finger/hand. As noted supra, in one example, pro-obtained digital image(s) of the regions of skin of a user's finger/hand can be obtained for use in the image/pattern recognition algorithms. Steps 104 and 106 can include various machine vision processes, including, inter alia: image acquisition processes, pre-processing (e.g. noise reduction, contrast enhancement, space-scaling, resampling, etc.), feature extraction, detection/segmentation, high-level processing and/or decision making. A data store of pre-obtained images (e.g. user region patterns 112) can be used for step 106. In step 108, the recognized region can be matched with a command or other input to an identified end device. A data store of end-device functions 114 can be used for the matching step(s) of step 108. In step 110, the function (and/or other input from step 108) can be triggered in the end device. Process 100 can return to step 102.

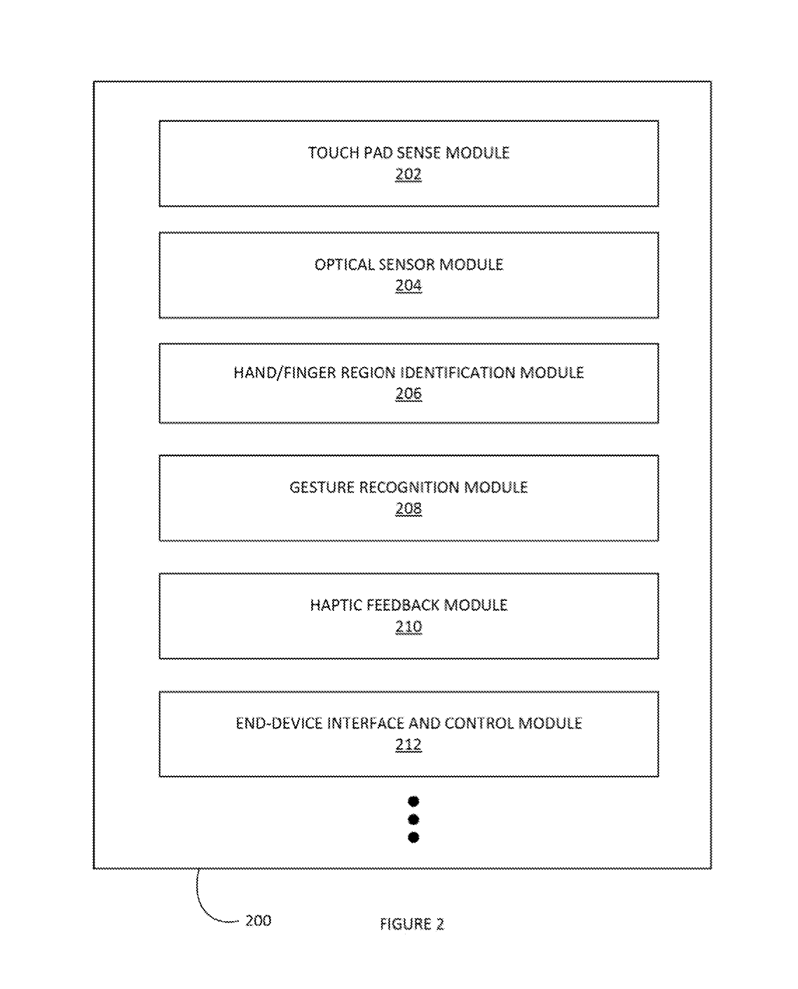

FIG. 2 depicts a block diagram of an example set of modules of a wearable ring device operating system 200, according to some embodiments. Wearable ring device operating system 200 can be used to implement various wearable ring device systems provided herein. Wearable ring device operating system 200 can be used to implement process 100. Wearable ring device operating system 200 can include touch pad sense module 202.

Touch pad sense module 202 can manage various touch sensors (e.g. skin detection sensor, touch switches, vibration detectors, etc.) of the wearable ring device. In some examples, a touch-sensitive region of the wearable ring device can be used to detect a user touch input to the wearable ring device. In some examples, wearable ring device can include sensor(s) (e.g. vibration sensors, etc.) for detecting a touch event to the digit on which the wearable ring device in worn and/or otherwise near the wearable ring device. In example, the wearable ring device can include a pad sensor that senses user finger ‘taps’. Tapping can then activate an optical sensor in the wearable ring device.

Optical sensor module 204 can manage various optical sensors. Hand/finger recognition module 206 can implement various pattern recognition and/or machine vision algorithms to match digital images of skin of user hand/finger regions with various signals to communicate to an end device. Gesture recognition module 208 can manage various devices (e.g. accelerometers, gyroscopes, OFN, electronic-field sensors such as electric field proximity sensors, etc.) used for obtaining user gesture and/or positional patterns. Gesture recognition module 208 can implement algorithms for interpreting this information. Haptic feedback module 210 can manage various haptic feedback systems (e.g. vibration motors). Haptic feedback module can provided haptic feedback using haptic patterns communicated to the user when a function has been completed, started and/or other information regarding an end device. End-device 212 can determine a command and/or other information to communicate to a specified end device. End-device 212 can manage various networking devices to implement said communications. For example, end-device 212 can manage a Bluetooth® system (and/or near field communication (NFC) or other wireless communication protocol system) in the wearable ring device. Wearable ring device operating system 200 can include other modules (not shown) such as LED display management modules, lighting control/detection modules, and the like.

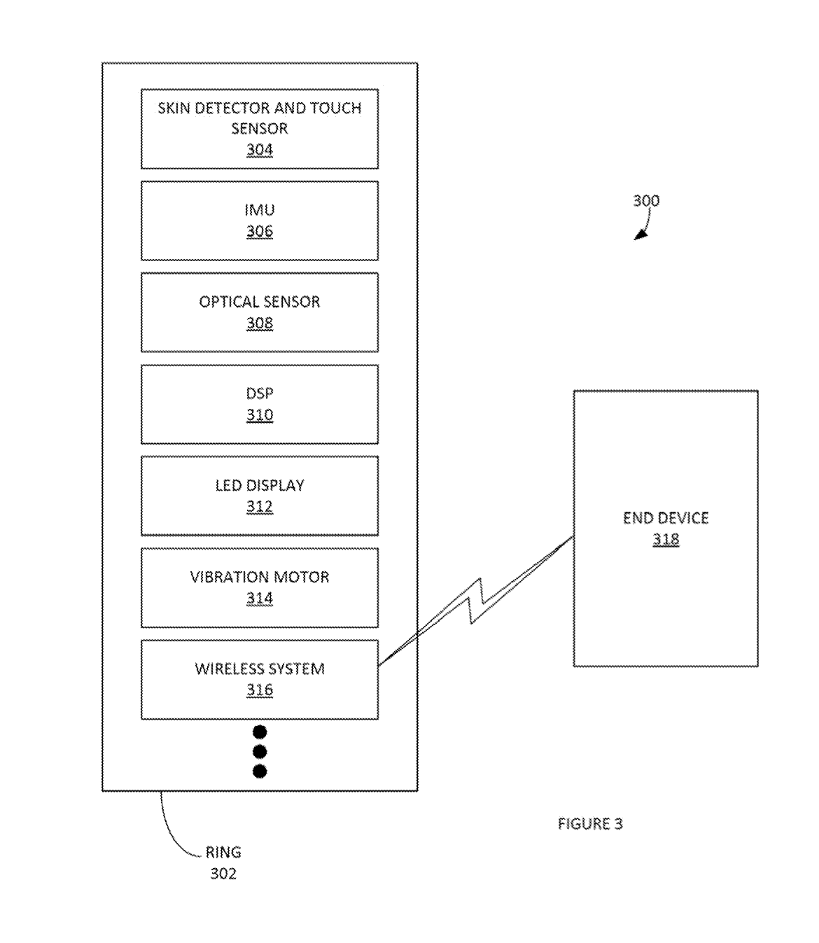

FIG. 3 depicts a block diagram of a system 300 that includes a wearable ring device 302 and an end device 318, according to some embodiments. It is noted that the wearable ring device can include additional hard-ware and/or soft-ware systems (e.g. a light source, an ambient light sensor, modules for determining ambient light values and turning on said light source, etc.). Wearable ring device 302 can include various systems (e.g. sensors, optical finger navigation (OFN) (e.g. such as Avago® OFN sensor, etc.), drivers, radios, LED's, accelerometers, gyroscopes, specialized processors, motors, etc.). For example, wearable ring device 302 can include a skin detector (e.g. a capacitance sensor, a resistance sensor, capacitive proximity sensors, proximity sensors, etc.) and/or other type of touch sensor 304, IMU 306, optical sensor 308, OFN sensor and/or digital signal processor (DSP) 310. Examples of these systems/devices are provided supra. Optionally, wearable ring device 302 can include and LED display(s) 312. LED display 312 can be an array of light-emitting diodes configured as a video display. Vibration motor 314 can provide haptic output to an issue. For example, specified vibration patterns can be match with specified output indicators. For example, a series of two half second vibrations can indicate that a text message was received by an end device smart phone. Wireless system 316 can include the hardware (e.g. a radio, antenna, etc.) and/or firmware components of a network device used for wireless communications with end device 318. The systems of FIG. 3 can provide and/or receive information with wearable ring device operating system 200.

In some embodiments, wearable ring, device 302 can include an integrated microphone system for voice recognition input by a user. Wearable ring device 302 can communicate voice data to the end device through Bluetooth® or other communication media. Wearable ring device 302 can process as well (e.g. a user can connect wearable ring device 302 with smart television (smartTV)). For example, voice input can be used, via wearable ring device 302, to implement such commands as, inter alia, search channel, control volume and/or select different options using voice commands. A user can wear wearable ring device 302 on the thumb and/or any other finger and input commands through voice. Additionally, a SmartTV can receive the voice data and/or send to a processing unit inside the SmartTV to recognize the voice command.

In some embodiments, Wearable ring device 302 can include an integrated Speaker system and/or microphone can be utilized as a call feature. Wearable ring device 302 can make a call and/or receive calls using gesture, speaker and user-voice input. For example, a user can create custom gestures using the wearable ring device 302. The Wearable ring device 302 can recognize these gestures. Wearable ring device 302 can utilize vibration and/or other haptic notifications. For example, an array of vibration sensors can be integrated into the wearable ring device 302. Additionally, any surface can be converted into a functionality to draw and/or gesture surface. For example, a user can convert any surface into draw table and/or gesture surface. Wearable ring device 302 can be utilized as an optical finger navigation (OFN) sensor system to detect x and y coordinates of user movement in any surface. X and y coordinates can be determined for gestures measured by wearable ring device 302 or can be communicated to an end device or remote server for gesture analysis.

Wearable ring device 302 can us electrical near-field (e.g. e-field) sensors and systems to detect a gesture on the palm , finger, hand and/or any other part of the human body or other surfaces. For example, the electrical near-field sensors and systems can attach to wearable ring device 302. Once the user moves the wearing finger and/or thumb over the palm, finger, hand, and/or any other part of the human body or other surfaces then the device can detect x, y and z coordinates of said movement.

A single wearable ring device 302 can control multiple end devices. A user can set unique gesture for each smart devices (e.g. a smart phone, a head-mounted display, an automobile, etc.) and save said gestures into a database. Once the user making a gesture for connecting to smartphone then wearable ring device 302 can communicate with the smartphone. If the user wishes to switch connection from the smartphone to Google Glass® then user can make appropriate gesture that assigned for Google Glass® to communicate with it.

FIGS. 4-8 illustrate non-limiting example schematics of a wearable ring device worn by a user, according to some embodiments. For example, FIG. 4 illustrates a wearable ring device 404 worn on the thumb of a user. Wearable ring device 404 can include the systems of FIGS. 2 and 3. A user can provide commands and/or other information (e.g. user authentication information) to an end device (not shown) with wearable ring device 404. For example, each control region can include distinct skin patterns. It is noted that, in some embodiments, the entire human palm or any surface (e.g. table top, wall, etc.) can act as a canvas. For example, when the user is drawing something on the palm using the thumb (e.g. thumb to palm direct interaction and/or wearable ring device 404 to palm interaction) a control gesture can be performed. In this way, various control gestures can be drawn different on the palm. A user can create custom control gestures. The user can touch portions of the wearable ring device (e.g. a digital camera 406) in wearable ring device 404 can capture all or a portion of the one of the control. regions. The identity of the control region can be identified, matched with a specified commands and/or other information. The output commands and/or other information can be communicated to an end device. It is noted that in some examples, various processes and/or steps performed in the wearable ring device 404 can be offload to other devices (e.g. the end device can receive the digital image and performing the matching step, wearable ring device 404 can obtain the digital images and provide them to another wearable ring device worn on the thumb and/or hand for processes and communication steps, etc.).

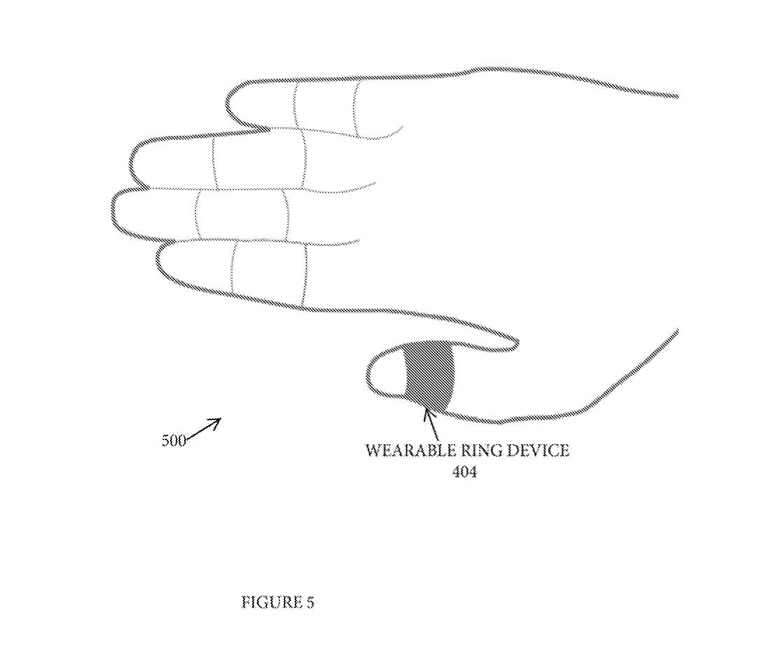

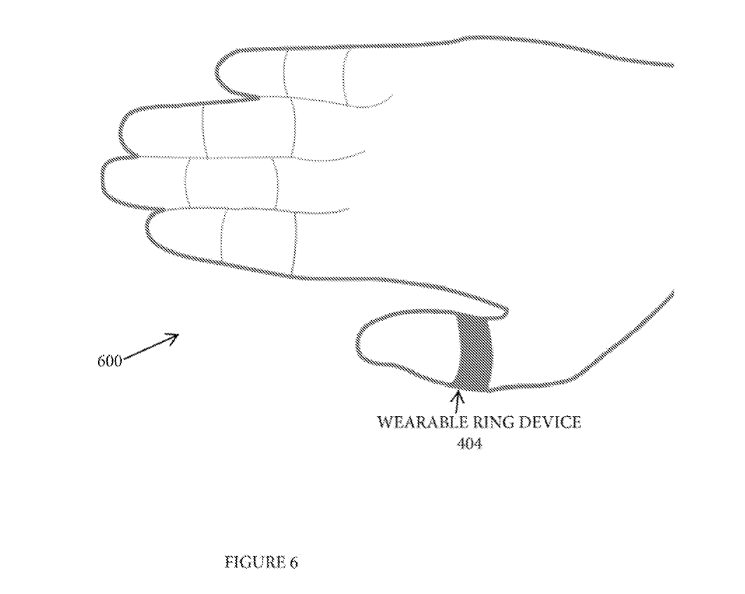

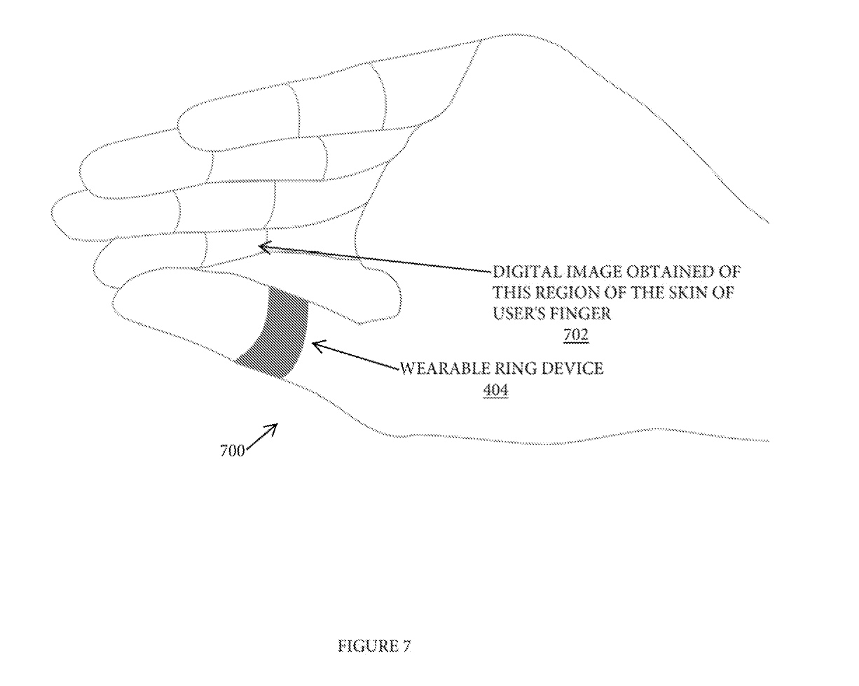

FIGS. 5 and 6 illustrate examples of a wearable ring device 404 worn in various positions. FIG. 7 illustrate an example hand posture/gesture position by which images of a control region can be obtained (e.g. via an optical sensor/digital camera 406) when (and/or approximately after) a touch event is detected by the wearable ring, device 702. It is noted that in some examples, certain hand motions/kinetic gestures can be combined with recently acquired digital image(s) to identify a command and/or other information to be provided to an end device. For example, touching the right index finger and turning the hand (or thumb) in a clockwise motion can be used to authenticate the user to an application in a smart phone.

It is noted that in some examples, the wearable ring device can be implemented as another type of worn non-ring and/or ring-like device. For example, modified versions of the system of FIGS. 2 and 3 can be included in other types of jewelry/worn object formats (e.g. toe rings, ear rings, glasses, bracelets, arm bands, leg bands, belts, etc.). The methods and systems provided herein can be modified accordingly.

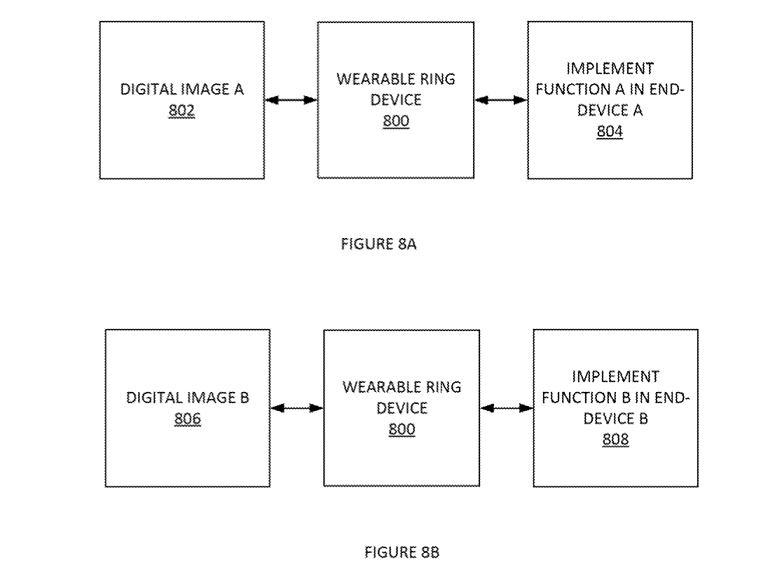

FIGS. 8A and 8B depicts an example system of implementing multiple functions in multiple end-devices with a single wearable ring device 800, according to some embodiments. Wearable ring device 800 can receive multiple inputs (e.g. digital images of regions of a user's hand such as finger pads, digital images of other objects, gesture input, etc.). An optical sensor in the wearable ring, device 800 can be trigger with a ‘tap’ to the ring, device and/or other user input. The user can then hold his/her hand in a specified position to obtain a certain digital image. For example, the wearable ring device can be oriented in a manner such that a digital image of a finger pad of the index finger is obtained. For example, digital image A 802 can be obtained. Wearable ring device 800 can then communicate digital image A 802 (and/or another control signal derived from the fact that digital image A 802 was obtained) to another computing device (e.g. end device A such as a wearable computer and/or a smart phone, etc.). End device A can match the incoming information with function A. Function A can then be implemented in end device A 804. in another example, digital image 13 806 can be obtained. Wearable ring device 800 can then communicate digital image B 806 (and/or another control signal derived from the filet that digital image B 806 was obtained) to another computing device (e.g. end device B such as a wearable computer and/or a smart phone, etc.). The end device B can match the incoming information with function B. Function B can then be implemented in end device B 808. In other examples, a user can wear multiple wearable ring devices. Each wearable ring device can be associated with one or more various end devices and provide control signals to said end devices. In some examples, a wearable ring device can be used to provide control signals to an end device and/or end device application that is, itself, a remote control for yet another subsequent computing device. Functions A and/or B can be application specific controls and not necessary operating system functions.

### ADDITIONAL EXAMPLE SYSTEM AND ARCHITECTURE

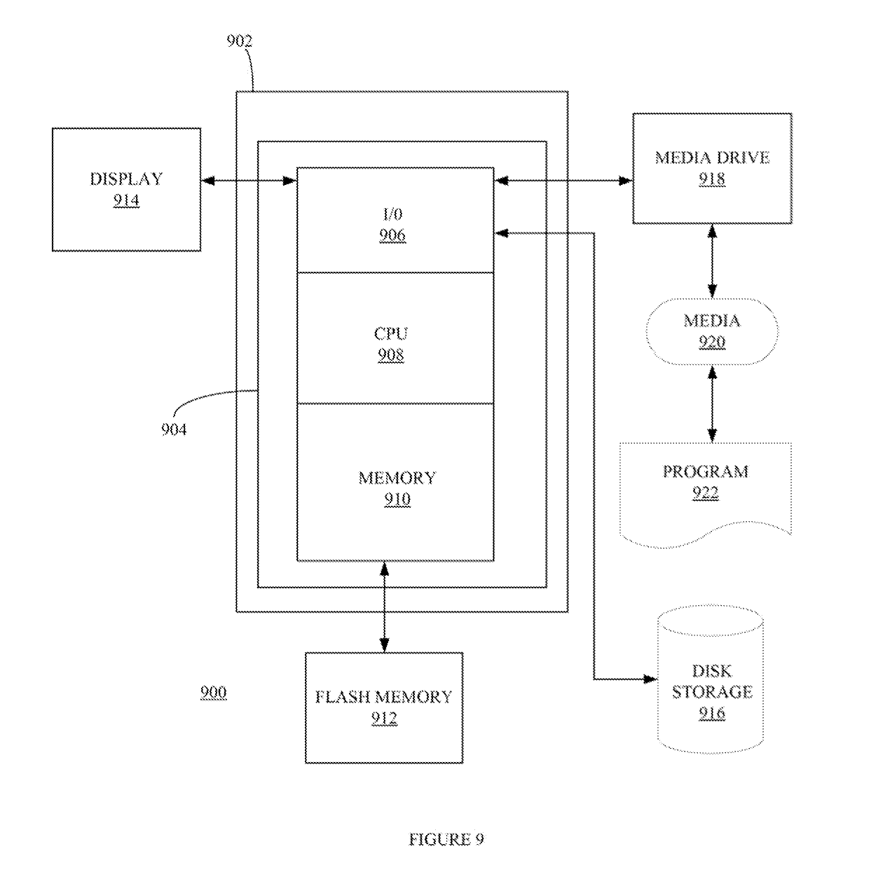

FIG. 9 depicts an exemplary computing system 900 that can be configured to perform any one of the processes provided herein. In this context, computing system 900 may include, for example, a processor, memory, storage, and I/O devices (e.g. monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an 110 section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918, The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### EXAMPLE USE CASES

Additional example use cases are now provided by way of example. In one example, a user can communicatively couple a wearable ring device with a mobile device. The mobile device can include, a home automation application (e.g. a Nest Labs® application). The home automation application can be used control and/or set the functionality parameters of various home and/or office appliances. A user can use pre-specified wearable device touch patterns to control specified aspects of the home automation application (e.g. using a wearable ring application in the mobile device that communicates user settings to the wearable ring device). Additionally, the home automation application can communicate to the user wearing the wearable ring device via haptic pattern output to the wearable ring device and/or LED display information. In this way, a user may feel that her office is too cold. She can tap her left index finger to the wearable ring device three times in succession. The wearable ring device can obtain digital images of a control region that it matches with a command to generate output to the home automation application in the user's proximate tablet. computer. The wearable ring device can then generate a command to turn on the office's heater. The wearable ring device can communicate this command to the tablet computer. The home automation application can then interact with a smart applicable smart appliance in the office and cause the heater to turn on. Later, the user may feel that the room temperature is correct. The home automation application can communicate to the wearable ring device that the user's preferred temperature has been achieved. The wearable ring device can provide a specified haptic vibration pattern alerting, the user. She can then perform another specified touch/gesture pattern that causes the home automation application to turn the heater off. In this way, the user can control her ambient temperature without the need to interrupt a conversation with her supervisor or other office visitor by access the home automation application in the tablet computer. Indeed, the guest may not even be aware of the interaction between the user and the home automation application because the user has kept her hand with the wearable ring device in her jacket pocket.

It is noted that wearable ring device commands can be integrated with video games systems. For example, a specified wearable ring device commands can be used implement a particular martial art move by a character in a martial art video game. The wearable ring device command may be faster to perform than other alternative input types and thus provide the player an advantage.

Wearable computers with outward facing cameras (e.g. Google Glass®) can be configured to associate one or more wearable ring device commands with various digital camera settings (e.g. cause a picture to be taken, modify of digital camera setting such as flash, aperture, speed, etc,). In this way, a user can obtain digital images with an outward facing camera using a wearable ring device on a finger in his pants pocket.

In another example, a user can be approaching her house or vehicle. The house and/or vehicle can be communicatively coupled with an end computing device. The user can utilize a wearable ring computer to obtain an image of her unique skin patterns (e.g. a finger print, a phalange and/or other line patterns in a region of a finger). The digital image can then be used by the wearable ring device and/or the end computing device to authenticate an identity of the user. The end device can then cause an automated system of the home or vehicle to perform specified operations. For example, the front door to the home can be unlocked, the lights in the kitchen can be turned on the stereo can begin playing a specified radio stations, a text message can be sent to the user's spouse indicating she has returned home, etc. In another example, the vehicle can unlock and a text message sent to a security service can be provided indicating the user is an authenticated user entering the vehicle. In this way, as user can perform authentication operations without having to access keys or perform other time consuming actions.

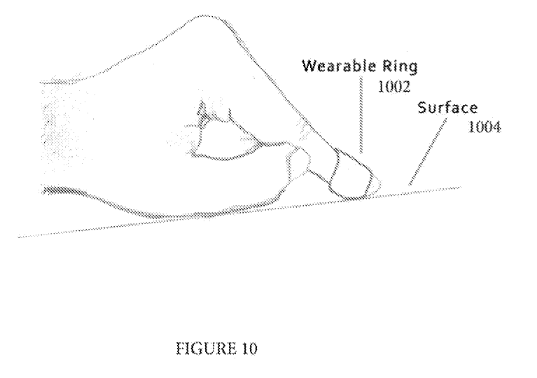

FIG. 10 illustrates an example of a wearable ring 1002 that utilizes an OFN sensor to recognize the gesture that making on any surface 1004 (e.g. user skin, cloths, glass, metal surface, wood surface, plastic surface etc.), according to some embodiments. For example, a user can wear the wearable ring on tip of the any fingers or thumb and draw in any surface. OFN sensors can obtain any x and y coordinates of user movement and/or transmit said coordinate values to end devices (e.g. a smart phone and/or other smart devices) or in the microcontroller inside the ring device itself to process and detect gestures. The gesture can be identified and end device functions performed.

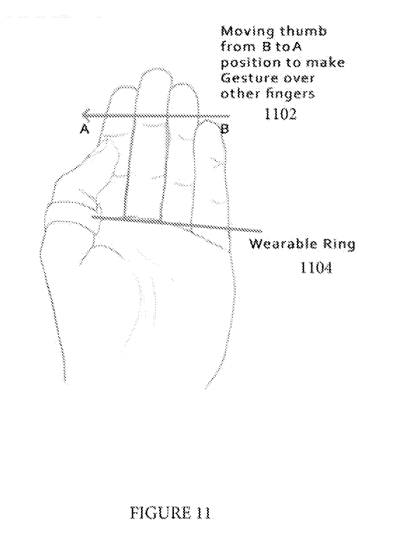

FIG. 11 illustrates an example of gesture controls by moving a thumb to perform gestures over one or more fingers 1102, according to some embodiments. As noted, Wearable ring 1104 can include sensors and/or systems provide obtained and communicating gesture controls (e.g. as provide supra). This can implemented utilizing an !MU and/or proximity sensors and/or GestIC® technology e.g. electronic-field sensors).

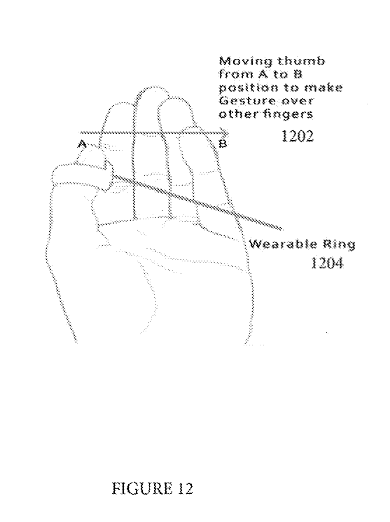

FIG. 12 illustrates another example of gesture controls by moving a thumb to perform gestures over one or more fingers 1202, according to some embodiments. As noted, wearable ring 1204 can include sensors and/or systems provide obtained and communicating, gesture controls (e.g. as provide supra). A user can create their own gesture for controlling multiple devices (e.g. a user can assign gesture of a motion in the shape of an ‘S’ for implementing a smartphone functionality, a ‘T’ shape for a Smart TV functionality, etc.) Once user is drawing the ‘S’ on any surface (e.g. a user hand, any other skin part, wood, glass, etc.) then said wearable ring device 1204 can identify the gesture ‘S’ (e.g. form accelerometer data, etc.) and immediately connect with the smart phone. If user is drawing ‘T’ on any surface then the wearable ring device 1204 can identify the gesture and communicate only with said Smart TV. In some examples, gesture controls can be implemented using OFN and/or optical sensors.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of wearable ring device comprising:
sensing a touch event with a touch sensor in a wearable ring device;
activating an optical sensor in the wearable ring device;
obtaining a digital image of a user hand region with the optical sensor;
obtaining a list of end device functions, wherein each element of the list of end device functions is associated with a different user hand region; and
matching the digital image of the user hand region obtained with the optical sensor with an end device function.

2. The method of claim 1 further comprising;
triggering the end device function matched with the digital image of the user hand region obtained with the optical sensor.

3. The method of claim 2, wherein the end device comprises a mobile device.

4. The method of claim 3, wherein the mobile device comprises a smart phone.

5. The method of claim 4, wherein the function comprises turning off a ringtone played by the smart phone.

6. The method of claim 1 further comprising:
providing a haptic feedback when the function in the end device is completed.

7. The method of claim 1 further comprising:
determining a user hand gesture pattern with an inertial measurement unit in the wearable ring device.

8. The method of claim 7, wherein each element of the list of end device functions is associated with a different user hand region and a different hand gesture pattern.

9. The method of claim 8 further comprising:
matching the digital image of the user hand region obtained with the optical sensor and the hand gesture pattern with an end device function; and
triggering the end device function matched with the digital image of the user hand region and the hand gesture pattern.

10. A computerized system of a wearable ring device comprising:
a processor configured to execute instructions;
a memory containing instructions when executed on the processor, causes the processor to perform operations that:
sense a touch event with a touch sensor in a wearable ring device;
activate an optical sensor in the wearable ring device;
obtain a digital image of a user hand region with the optical sensor;
obtain a list of end device functions, wherein each element of the list of end device functions is associated with a separate user hand region;
match the digital image of the user hand region obtained with the optical sensor with an end device function; and
trigger the end device function matched with the digital image of the user hand. region.

11. The computerized system of a wearable ring device of claim 10, wherein the wearable ring, device measures a gesture pattern in within a hand palm or a surface and determines a gesture input instruction.

12. The computerized system of a wearable ring device of claim 10, wherein the gesture pattern is generated by a thumb or a finger within the palm or across other fingers of the same hand or the surface interacted with by the thumb or the finger.

13. The computerized system of a wearable ring device of claim 12, wherein the function comprises obtaining another digital image with a digital camera associated of the optical head-mounted display.

14. The method of claim 11, wherein each element of the list of end device functions is associated with a different user hand region and a different hand gesture pattern.

15. The computerized system of a wearable ring, device of claim 14, wherein the memory containing instructions when executed on the processor, causes the processor to perform operations that:
match the digital image of the user hand region obtained with the optical sensor and the hand gesture pattern with an end device function.

16. The computerized system of a wearable ring device of claim 15, wherein the memory containing, instructions when executed on the processor, causes the processor to perform operations that:
trigger the end device function matched with the digital image of the user hand region and the hand gesture pattern,

17. The computerized system of a wearable ring device of claim 10, wherein the memory containing instructions when executed on the processor, causes the processor to perform operations that:
obtain another digital image of another user hand region with the optical sensor; and

18. The computerized system of a wearable ring device of claim 10, wherein the memory containing instructions when executed on the processor, causes the processor to perform operations that:
match the other digital image of the other user hand region obtained with the optical sensor with another end device function; and
trigger the other end device function matched with the other digital image.

19. The computerized system of a wearable ring device of claim 10, wherein the end-device function comprises a control of a subsequent computing device.

20. The computerized system ala wearable ring device of claim 10, wherein the end-device function comprises a control of an application function within the end device.
